(19) United States
(12) Patent Application Publication
(10) Pub. No.: US 2010/0012143 A1
(43) Pub. Date: Jan. 21, 2010

(54) Hair Styling Appliance with Continuous Pressure

(76) Inventors: Benedicte SIMOND, Rumilly (FR); Marc Legrain, Civrieux En Dombes (FR); Xavier Vacheron, Genas (FR)

Correspondence Address: BROWDY AND NEIMARK, P.L.L.C.;624 NINTH STREET, NW, SUITE 300, WASHINGTON, DC, 20001-5303, US

(21) Appl. No.: 12/175,419

(22) Filed: Jul. 17, 2008

(30) Foreign Application Priority Data
Jul. 15, 2008 (EP) EP-08356106.8

(51) Int. Cl. A45D 2/00; A45D 1/04; H05B 1/00

(52) U.S. Cl. 132/223; 132/269; 219/225; 219/227

(57) ABSTRACT

The invention relates to a hairstyling device (1) comprising two jaws (2, 3), each supporting at one end a treatment surface (10, 11), at least one of which includes a heating element, said jaws (2, 3) being mounted so as to pivot about a hinge (4) at the other end between an open position that allows the hair to be inserted between the two treatment surfaces (10, 11) and a closed position for placing it in contact with the two treatment surfaces (10, 11), said jaws (2, 3) forming two handle halves (5, 6) between the treatment surfaces (10, 11) and the hinge.

According to the invention, the device (1) includes return means for the handle halves (5, 6), which cause pressure to be applied to the treatment surfaces (10, 11).

The present invention relates to a device for styling or shaping the hair, more particularly of the type for crimping or straightening the hair, and more particularly, a device comprising a mechanism provided for exerting pressure on the lock of hair to be treated.

Most hair-shaping devices, for example straightening and crimping irons, comprise two pivoting jaws, each supporting at one end a treatment surface, at least one of which is heated, the other of which is provided for bringing the hair into contact with the first one, particularly by moving from an open position of the jaws that allows the hair to be inserted to a closed position for placing it in contact with the heating part. The other end of the jaws forms two handle halves that serve as a grasping area and make it possible to move from the open position to the closed one. This movement is produced manually by pressing the two hinged handle halves of the device toward one another so as to bring the heating part into contact with the hair.

These devices have the drawback of requiring continuous strong pressure by the user on the handle halves throughout the treatment in order to obtain a good treatment result. This results in a tedious and tiresome operation for the user.

There is a first known type of device wherein the pivot point of the jaws is disposed between the handle halves and the treatment surfaces. This arrangement has the drawback of requiring a large angular stroke of the handle halves in order to obtain a sufficient opening of the treatment surfaces, which is necessary in order for the locks of hair to be inserted.

There is a second known type of device wherein the pivot point of the jaws is disposed at the opposite end of these jaws from the treatment surfaces. This arrangement offers improved ergonomics compared to the first type of device; in essence, the handle halves have a smaller angular stroke for obtaining a sufficient opening of the treatment surfaces.

However, this arrangement has the drawback of requiring substantial pressure from the user on the handle halves in order to obtain a sufficient force of the treatment surfaces on the hair, it being understood that the intensity and the evenness of this force are important factors in the treatment result obtained.

The object of the present invention is to eliminate the aforementioned drawbacks and to propose a hairstyling device that is capable of performing a good shaping of the hair while being easy to use and requiring no particular effort to operate.

Another object of the invention is to propose a hairstyling device having a simplified, compact structure that can be mass-produced at a low cost.

These objects are achieved with a hairstyling device comprising two jaws, each supporting at one end a treatment surface, at least one of which includes a heating element, said jaws being mounted so as to pivot about a hinge at the other end between an open position that allows the hair to be inserted between the two treatment surfaces and a closed position for placing it in contact with the two treatment surfaces, said jaws forming two handle halves between the treatment surfaces and the hinge, characterized in that the device includes return means for the handle halves, which cause pressure to be applied to the treatment surfaces.

According to the invention, pressure is maintained on the treatment surfaces, making it possible to apply a continuous force on the hair without intervention from the user. Thus, the user inserts the hair between the treatment surfaces while exerting pressure on the handle halves. The hair is then shaped simply by moving the device, the return means of the handle halves applying pressure on the treatment surfaces, thus guaranteeing a continuous force on the hair.

The user can also periodically limit the force on the hair during the treatment by applying slight pressure on the handle halves.

Advantageously, the jaws include an intersecting area.

This feature makes it possible to obtain a simplified structure of the device for inverting the movements of the handle halves and the treatment surfaces: the closing of the handle halves by a pressure by the user causes the treatment surfaces to open and the opening of the handle halves under the effect of the return means causes the treatment surfaces to close. This guarantees an application of pressure to the treatment surfaces without intervention from the user.

Preferably, the return means of the handle halves include a device for adjusting the pressure applied to the treatment surfaces.

This feature enables the user to adapt the pressure of the treatment surfaces on the hair as a function of the quantity, nature, and type of hair disposed between the surfaces.

Advantageously, the return means of the handle halves include a compression spring.

This feature makes it possible to embody the return means of the handle halves very simply. This type of spring makes it possible to obtain a linear-shaped variation curve of the force exerted on the treatment surfaces as a function of the opening angle of the handle halves.

Preferably, the return means of the handle halves include a spiral torsion spring.

This type of spring makes it possible to obtain a variation curve of the force exerted on the treatment surfaces as a function of the opening angle of the handle halves that is in the shape of a polynomial of degree greater than 2.

Advantageously, the two hair treatment surfaces are constituted by two smooth plates for straightening the hair.

This feature makes it possible to obtain a shaping device that straightens the hair.

According to another embodiment, the two hair treatment surfaces are constituted by two plates having complementary relief patterns for crimping the hair.

This feature makes it possible to obtain a shaping device that crimps the hair in successive pressings.

In a variant of embodiment, the two hair treatment surfaces are constituted by two rotating rollers.

This feature makes it possible to obtain a shaping device that crimps the hair using continuous pressure.

The invention will be more clearly understood through the study of the embodiment taken as a nonlimiting example and illustrated in the attached figures, in which:

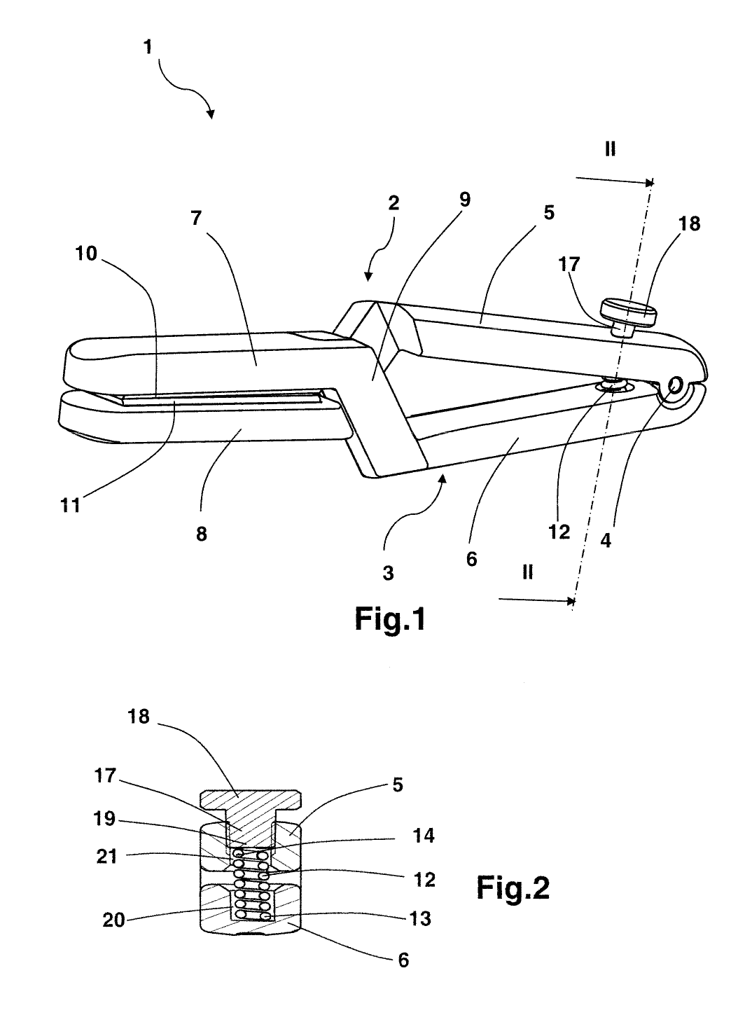

FIG. 1 illustrates a perspective view of the device according to a particular embodiment of the invention with the treatment surfaces closed.

FIG. 2 illustrates a sectional view along line II-II of the device of FIG. 1.

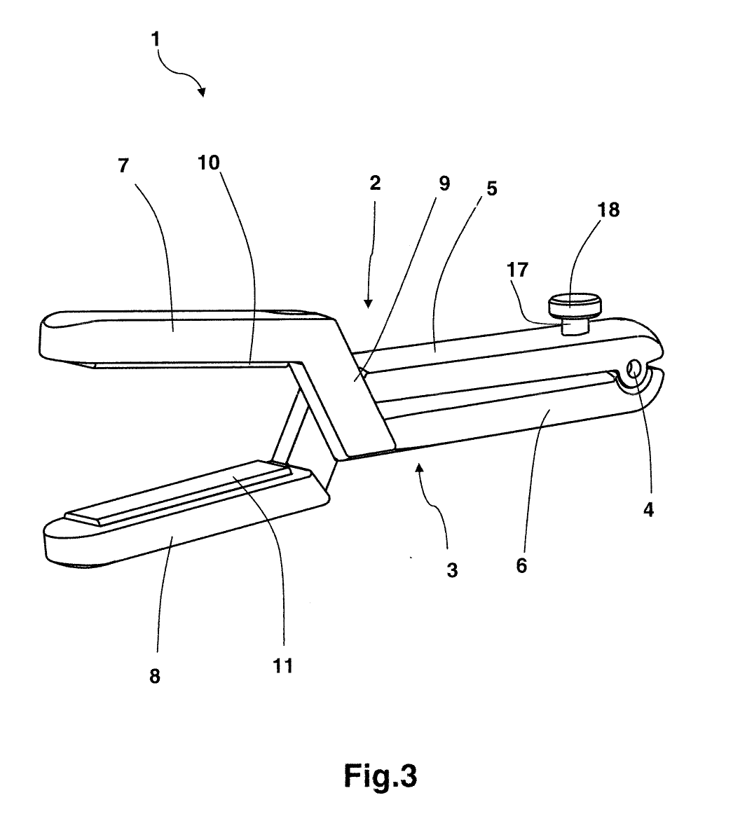

FIG. 3 illustrates a view of the device of FIG. 1 with the treatment surfaces open.

FIG. 1 illustrates a device 1 that is a straightening iron according to a preferred embodiment of the invention, the device being in the closed position. The device 1 comprises two jaws 2, 3 pivotably mounted about a hinge 4. The hinge is equipped at the back with a socket capable of receiving a rotary connector for a main power supply cord (not shown in the figures). Each jaw 2, 3 includes on the front part a housing 7, 8 capable of receiving a straightening plate 10, 11. The housings 7, 8 are advantageously made from a plastic material using an injection molding technique.

Each jaw includes a rear part, i.e., between the front part and the hinge, that forms a grasping area composed of two handle halves 5, 6, one upper and one lower, similar to a pair of tongs.

Each straightening plate 10, 11 encloses a heating element (not shown in the figures), which can be a resistance, PTC, infrared or other type of electrical heating element, supplied with energy by a switch that receives the power supply from the main power cord of the device. The heating element is placed in thermal contact with the straightening plate 10, 11 so as to transfer all of its calories to it. The straightening plate 10, 11 is made of a metal material that is a good heat conductor, such as aluminum or its alloys, copper or its alloys, or steel.

Each jaw 2, 3 includes an intersecting area 9 between the ends of the handle halves 5, 6 and the housings 7, 8 where the jaws 2, 3 have a thinner cross-section in order to maintain a substantially constant width along the length of the device 1.

A compression spring 12 is disposed between the two handle halves 5, 6. A device for adjusting the pressure applied to the treatment surfaces is constituted by a screw 17 for adjusting the length of the spring 12. The spring 12 has a first end 13 (FIG. 2) anchored in a seat 20 provided in the lower handle half 6 and a second end 14 slide-mounted in a seat 21 provided in the upper handle half 5 so as to press against a first end 19 of the adjusting screw 17. The screw 17 is mounted in a threaded opening of the upper handle half 5, in the extension of the seat 21. The screw 17 has a second end formed by a knurled knob 18 that can be rotated by the user.

In operation, after the device 1 has come to temperature, the user exerts a pressure on the handle halves 5, 6, thereby compressing the spring 12 so as to separate the straightening plates 10, 11 to the maximum, as seen in FIG. 3. The device 1 is then in the open position. The user inserts a lock of hair between the straightening plates 10, 11, preferably placing the device 1 as close as possible to the scalp. She then completely releases the pressure on the handle halves 5, 6, which has the effect, under the pressure of the spring 12, of squeezing the lock of hair between the straightening plates 10, 11. The user then moves the device 1 along the lock of hair, from the root to the end of the hair, without having to exert a pressing force on the handle halves 5, 6 during the straightening. The user can also periodically limit the force of the straightening plates 10, 11 on the hair during the treatment by applying a slight pressure on the handle halves 5, 6, for example at the end of the lock of hair.

The user can modify the pressure of the straightening plates 10, 11 on the hair at any time by turning the knurled knob 18.

In a variant that is not illustrated, the return spring of the handle halves is a torsion spring comprising a spiral body disposed in the hinge and two arms, each of which presses against the inside of a handle half.

In another variant that is not illustrated, the treatment surfaces are constituted by two plates having complementary relief patterns for crimping the hair, the device being a set of crimping or curling tongs.

In another variant that is not illustrated, the treatment surfaces are constituted by two rotating rollers, one of which is driven by a motor, for shaping the hair continuously.

It is understood that the invention is not in any way limited to the embodiment described and illustrated, which is given only as an example. Other modifications remain possible, particularly from the point of view of the structure of the various elements or the substitution of technical equivalents, without going beyond the scope of protection of the invention.

Thus, the jaws can include, in the intersecting area, one or more pivot pins, thus making it possible to modify the angular position of the treatment surfaces in a longitudinal direction of the device.

In another embodiment, each of the jaws can include in the intersecting area a connecting rod joining the handle half to the treatment surface and a pivot pin on each end of the connecting rod, thus making it possible to adjust the opening of the treatment surfaces.

In the sense of the invention in which it comprises a set of normally closed tongs, it is conceivable for the jaws to be straight and for a traction spring disposed between the handle halves to cause the treatment surfaces to move toward one another so as to apply pressure to them. The handle halves have a cavity between them that allows the fingers to be inserted in order to force them open.

1. Hairstyling device (1) comprising two jaws (2, 3), each supporting at one end a treatment surface (10, 11), at least one of which includes a heating element, said jaws (2, 3) being mounted so as to pivot about a hinge (4) at the other end between an open position that allows the hair to be inserted between the two treatment surfaces (10, 11) and a closed position for placing it in contact with the two treatment surfaces (10, 11), said jaws (2, 3) forming two handle halves (5, 6) between the treatment surfaces (10, 11) and the hinge, characterized in that the device (1) includes return means for the handle halves (5, 6), that cause pressure to be applied to the treatment surfaces (10, 11).

2. Hairstyling device (1) according to claim 1, characterized in that the jaws (2, 3) include an intersecting area (9).

3. Hairstyling device (1) according to claim 2, characterized in that the return means of the handle halves (5, 6) include a device (17) for adjusting the pressure applied to the treatment surfaces.

4. Hairstyling device (1) according to claim 3, characterized in that the return means of the handle halves (5, 6) include a compression spring (12).

5. (canceled)

6. Hairstyling device (1) according to claim 1, characterized in that the two hair treatment surfaces are constituted by two smooth plates (10, 11) for straightening the hair.

7-8. (canceled)

9. Hairstyling device (1) according to claim 1, characterized in that the return means of the handle halves (5, 6) include a device (17) for adjusting the pressure applied to the treatment surfaces.

10. Hairstyling device (1) according to claim 1, characterized in that the return means of the handle halves (5, 6) include a compression spring (12).

11. Hairstyling device (1) according to claim 1, characterized in that the two hair treatment surfaces are constituted by two smooth plates (10, 11) for straightening the hair.
